(19) United States
(12) Patent Application Publication
(10) Pub. No.: US 2024/0183652 A1
(43) Pub. Date: Jun. 6, 2024

(54) METHOD FOR OPERATING A COOKING APPLIANCE, AND COOKING APPLIANCE

(71) Applicant: Miele & Cie. KG, Guetersloh (DE)

(72) Inventor: Hannes LAESSIG, Bielefeld (DE)

(21) Appl. No.: 18/553,220

(22) PCT Filed: Apr. 6, 2022
(86) PCT No.: PCT/EP2022/059105

§ 371 Date: Sep. 29, 2023

(30) Foreign Application Priority Data
Apr. 12, 2021 (BE) 2021/5283

(51) Int. Cl. G01B 11/24; F24C 7/08

(52) U.S. Cl. CPC G01B 11/24; F24C 7/085

(57) ABSTRACT

A method for operating a cooking appliance having a cooking chamber for receiving a food product positioned on a food support, a treatment device for treating the food product, a control device for controlling at least the treatment device, and an image capture device for capturing images of the cooking chamber, the method including: successively capturing, using the image capture device, a plurality of 2D images of the food product, in each 2D image of the plurality of 2D images the food support being in a different insertion position, the insertion position being varied at least in insertion height and/or insertion depth; generating 3D information about a shape and/or dimensions of the food product by comparing geometric data of the food product in the plurality of 2D images; and using the 3D information to control the treatment device.

### CROSS-REFERENCE TO PRIOR APPLICATIONS

This application is a U.S. National Phase application under 35 U.S.C. § 371 of International Application No. PCT/EP2022/059105, filed on Apr. 6, 2022, and claims benefit to Belgian Patent Application No. BE 2021/5283, filed on Apr. 12, 2021. The International Application was published in German on Oct. 20, 2022 as WO/2022/218775 A1 under PCT Article 21(2).

### FIELD

The present invention relates to a method for operating a cooking appliance having a cooking chamber for receiving a food product positioned on a food support, a treatment device for treating the food product, a control device for controlling at least the treatment device, as well as an image capture device for capturing images of the cooking chamber. The present invention also relates to a corresponding cooking appliance.

### BACKGROUND

Today's cooking appliances have a variety of assistance and automatic functions for automatically detecting information about the food product. Based on this data, the cooking process can be precisely tailored to the food product to be prepared, which leads to a better cooking result. In particular, 3D information about the food product is useful for this purpose because it can be used, for example, to draw conclusions about the type, mass, quantity, and/or other properties of the food product, and to optimally adapt the cooking process based on the conclusions drawn.

3D information about the food product can be obtained, for example, with 3D cameras, such as stereo cameras or camera systems having multiple cameras or multiple objectives. However, the implementation of such camera systems is complex and costly.

DE 10 2019 204 531 A1 describes using a permanently mounted camera directed at the food product in conjunction with a movable projection device that projects lines onto the food product from different orientations. 3D information about the food product can be calculated from a plurality of 2D images, each with different projections on the food product. However, this method has the disadvantage that the installation of such a projection device is associated with high manufacturing complexity and cost.

### SUMMARY

In an embodiment, the present invention provides a method for operating a cooking appliance having a cooking chamber for receiving a food product positioned on a food support, a treatment device for treating the food product, a control device for controlling at least the treatment device, and an image capture device for capturing images of the cooking chamber, the method comprising: successively capturing, using the image capture device, a plurality of 2D images of the food product, in each 2D image of the plurality of 2D images the food support being in a different insertion position, the insertion position being varied at least in insertion height and/or insertion depth; generating 3D information about a shape and/or dimensions of the food product by comparing geometric data of the food product in the plurality of 2D images; and using the 3D information for controlling the treatment device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an embodiment of a cooking appliance according to the invention;

FIG. 2 shows the inventive cooking appliance of FIG. 1 with a varied insertion depth of the food support;

FIG. 3 shows another embodiment of the cooking appliance according to the invention;

FIG. 4 shows a further embodiment of the cooking appliance according to the invention; and

FIG. 5 shows the inventive cooking appliance of FIG. 4 with a varied insertion height of the food support.

### DETAILED DESCRIPTION

In an embodiment, the present invention provides an improved method and a corresponding improved cooking appliance which make it possible to reliably obtain 3D information and, in particular, to overcome the disadvantages of the prior art.

The method according to the invention is used for operating a cooking appliance having a cooking chamber for receiving a food product positioned on a food support. The cooking appliance has a treatment device for treating the food product, a control device for controlling at least the treatment device, as well as an image capture device for capturing images of the cooking chamber. The method is characterized in that a plurality of successively captured 2D images of the food product is produced by means of the image capture device. In each of these 2D images, the food support is in a different insertion position, the insertion position being varied at least in terms of its insertion height and/or its insertion depth. 3D information about the shape and/or dimensions of the food product is generated by comparing geometric data of the food product in the 2D images, and this 3D information is taken into account in controlling the treatment device.

In order to vary the angle of view of the image capture device toward the food product, the inventive method focuses on the variable insertion position of the food support carrying the food product. The food support may, for example, be in the form of an oven grate or baking sheet. The food support, which is usually oriented parallel to the cooking chamber bottom, can be displaced in terms of its insertion depth; i.e. parallel to the cooking chamber bottom, and/or in its insertion height; i.e. perpendicularly to the cooking chamber bottom. This provides a particularly simple and cost-effective way to capture 2D images from different viewing angles. Knowing the position of the food product in relation to the image capture device, it is possible to determine the respective angle of view and to compute 3D information about the food product from a plurality of 2D images with different viewing angles. The 3D information so obtained can be taken into account in controlling the treatment device, in particular to control automatic cooking programs, so that the cooking result can be significantly improved. Since the insertion position of the food support is usually varied at least once during use of the cooking appliance (e.g., when inserting the food support into the cooking chamber), the acquisition of the 2D images can in these cases take place in parallel with the usual operation of the cooking appliance and thus discreetly and without being noticed by the user.

In particular, in the method according to the invention, neither complex camera technology nor a movable projection device is required to obtain 3D information about the food product. Rather, the method according to the invention can be carried out using a conventional, in particular permanently mounted camera, as is used already in a variety of cooking appliances. In the case of cooking appliances which are already equipped with an image capture device, for example, in the form of a (2D) camera directed into the cooking chamber, the inventive method can be cost-effectively implemented or retrofitted, for example by means of a simple software update. Preferably, the image capture device includes an in particular permanently mounted camera.

As used herein, a “2D image” is understood to be any type of data set captured by an optical sensor that is included in the image capture device and captures data about color values of individual measurement points and/or measurement areas and makes it available, in particular, for the purpose of analysis. In this context, a color value is understood in particular to be a coordinate of a color in a multi-dimensional color space (e.g., RGB, CIELAB, CIEJUV, etc.).

The geometric data of the food product or of the food support in the 2D images is understood in particular to be the dimensions (length, width, and possibly diameter), the area, shape, and/or contour of the food product or of the food support. The 3D information about the food product is understood in particular to be the dimensions of the food product in three dimensions, for example, in three orthogonal directions (length, width, height). In particular, the 3D information about the food product is also understood to be the volume, shape, contour, and/or surface condition of the food product.

Preferably, the cooking appliance and/or the image capture device have/has an analyzing device that analyzes the captured 2D images to generate the 3D information about the food product. Alternatively or additionally, the analysis may be at least partially performed externally, for example, on a server or in a cloud, and for this purpose the cooking appliance and/or the image capture device may be equipped with corresponding communication interfaces. Preferably, the analyzing device is suitable and adapted to acquire and compare geometric data of the food product and/or of the food support in the 2D images. Preferably, the analyzing device is suitable and adapted to generate 3D information about the food product based on the 2D images captured from different angles of view. In particular, the analyzing device is suitable and adapted to draw conclusions on the type, quantity, mass, and/or other properties of the food product based on the 3D information. The analysis of the 2D images and/or of the 3D information preferably includes comparing the data with references in a database. In this connection, in particular, a classification of the food product and/or of the food support is performed using statistical and/or analytical methods, such as, for example, variance analysis and/or (support vector) regression. Alternatively or additionally, the analysis may include classifying the food product and/or the food support using an artificial neural network, in particular using an artificial neural network trained with a large number of references, and/or by means of deep learning. After the analysis, certain control signals can be transmitted to the control unit of the treatment device depending on the result of the analysis. The analysis device is in particular part of the control device, or the control device serves at the same time as an analysis device. Alternatively, the analysis device may be configured as an independent unit including a processor, a memory, communication interfaces, and/or further components for electronic data processing, and may be connected, in data-transmitting relationship, to the control device of the cooking appliance, either wirelessly or in a wired manner.

Examples of cooking appliances that may be used in the context of this invention include ranges, ovens, oven combination appliances with steam cooking and/or microwave function, ovens with high-frequency technology, as well as microwave ovens. The term “food product” as used within the scope of the present invention is understood to include also food to be thawed, which can be treated (i.e., thawed) by moderate heating, for example.

Preferably, the treatment device includes at least one thermal heat source for thermal treatment of the food product and/or at least one high-frequency generator for dielectric heating of the food product. The treatment device may include a bottom heat source, a top heat source, a grill heater, and/or a circulation fan equipped with a ring heating element as a thermal heat source. The treatment device includes in particular a steam generator. In particular, the power input of the treatment device is set based on the 3D information about the food product or based on the properties of the food product derived from the 3D information. For example, it is possible to set the duration and/or pulsing of a thermal heat source for thermal treatment of the food product and/or of a high-frequency generator for dielectric heating of the food product. It is also possible that a program selection and/or program adjustment is made based on the 3D information about the food product or based on the properties of the food product derived from the 3D information. For example, the cooking time of a program may be extended or shortened and/or the cooking temperature of a program may be increased or lowered depending on a determined mass of the food product. It is also possible to generate program suggestions suitable for the food product, which may be output to the user for selection.

In a preferred embodiment of the invention, the respective insertion positions of the food support shown in the different 2D images are compared with each other in generating the 3D information. By comparing the easily detectable insertion positions of the food support, the respective position of the food product in relation to the image capture device can be determined with particularly high accuracy, which enables the generation of particularly reliable 3D information.

In another preferred embodiment of the invention, a variation of the insertion position of the food support between different 2D images is determined by sensor means. This makes it possible to automatically and reliably determine the position of the food support and of the food product located thereon in relation to the image capture device as well as the variation of the insertion position between two 2D images. This information allows 3D information about the food product to be determined with particularly high accuracy. For example, the insertion position of the food support can be detected by means of touch-sensitive sensors (e.g., by means of electromechanical switches) and/or non-contact sensors (e.g., by means of optical, capacitive, or inductive sensors). Such sensors may be disposed, for example, in the region of the food support holders, which are typically arranged on the side walls of the cooking chamber and which may be in the form of guide rails, for example. If the cooking appliance has food support holders (e.g., in the form of a telescoping rail assembly) which are movable by motor means, the control signals provided for this purpose can be used to determine the exact insertion position.

In a further preferred embodiment of the invention, a variation of the insertion position of the food support between the different 2D images is determined by means of image analysis. Since the geometry and/or the appearance of the particular food supports that are compatible with the cooking appliance are generally known, the insertion position can be determined with particularly high accuracy by analyzing, for example, geometric data of the food support in the respective 2D image, such as, for example, its outer edge lengths and/or its area. This enables the generation of particularly reliable 3D information. Moreover, this eliminates the need for additional sensors for determining the insertion depth and/or the height of the food support, which allows the method to be implemented in a particularly cost-effective manner, for example by a simple software update. However, the determination of the insertion position by means of image analysis may also be performed in addition to a sensor-based determination of the insertion position.

In another preferred embodiment of the invention, special markings on the food support are taken into account to determine the variation of the insertion position of the food support between different 2D images. Thus, as an alternative or in addition to the usually previously known geometry and/or appearance of the food support, other visually recognizable features on the food support can be taken into account in the image analysis, thereby enabling a more accurate determination of the insertion position. Examples of special markings include embossments, imprints, recesses, elevations, or other suitable features.

In a further preferred embodiment of the invention, the image capture device has an optical axis, which, during capture of the 2D images, is inclined relative to a vertical, in particular by 10° to 50°, preferably by 20° to 40°. In this way, when the insertion depth or the insertion height of the food support varies, the imaging angle varies to a greater extent because both the distance of the food product to the image capture device and the distance of the food product to the optical axis of the image capture device always change in the process. Preferably, the optical axis is inclined from a perspective transverse to the insertion direction and transverse to the height direction, which is perpendicular to the cooking chamber bottom.

In a further preferred embodiment of the invention, at least a portion of the 2D images is captured during insertion of the food support into the cooking chamber. The insertion of the food support into the cooking chamber, during which process the food support is in particular guided on a food support holder (e.g., in the form of guide rails), can essentially be described as a linear movement in a horizontal plane parallel to the cooking chamber bottom. With this boundary condition, the variation of the position of the food product and/or of the insertion position of the food support between different 2D images can be calculated in a particularly easy and accurate manner. This greatly simplifies the analysis, so that the method can be implemented with less effort. The insertion can be carried out manually or automatically by means of a food support holder (e.g., in the form of a telescoping rail assembly) that is movable by motor means.

Preferably, the insertion is carried out by motorized retraction of the food support holder and in particular at a constant speed. This ensures that the variation of the insertion position can be described as a nearly ideal linear movement with known start and end points in a horizontal plane parallel to the cooking chamber bottom, which enables an even more accurate determination of the position of the food product and/or of the insertion position of the food support. In this connection, in particular, the control signals for the food support holder can be used to determine the exact insertion position. By capturing the 2D images while the food support is inserted at a constant speed, the respective position of the food product and/or of the respective insertion position of the food support can be determined particularly easily, which greatly simplifies the analysis.

In a further preferred embodiment of the invention, at least a portion of the 2D images is captured during a motorized height adjustment of a food support holder, the height adjustment in particular being carried out at a constant speed. The height adjustment of the food support in the cooking chamber, during which process the food support is in particular guided on a food support holder (e.g., in the form of guide rails), can be described as a nearly ideal linear movement with known start and end points in a direction perpendicular to the cooking chamber bottom. With this boundary condition, the variation of the position of the food product and/or of the insertion position of the food support between different 2D images can be calculated in a particularly easy and accurate manner. This greatly simplifies the analysis, so that the method can be implemented with less effort. By capturing the 2D images while the height of the food support is adjusted at a constant speed, the respective position of the food product and/or of the respective insertion position of the food support can be determined particularly easily, which greatly simplifies the analysis.

The cooking appliance according to the invention has a cooking chamber for receiving a food product positioned on a food support, a treatment device for treating the food product, a control device for controlling at least the treatment device, as well as an image capture device for capturing images of the cooking chamber. The cooking appliance according to the invention is characterized in that it is suitable and adapted to carry out the method described herein. For example, the cooking appliance is configured by the control device to carry out a method described herein.

The cooking appliance according to the invention provides in particular the same advantages as those of the method according to the invention.

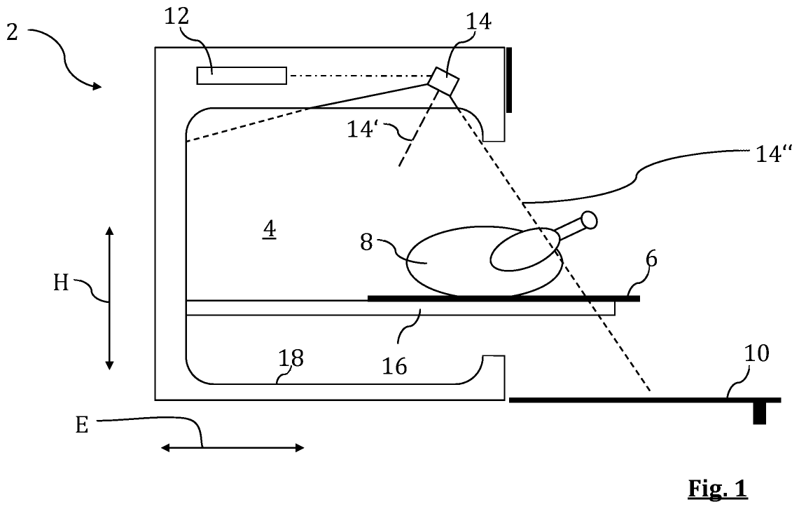

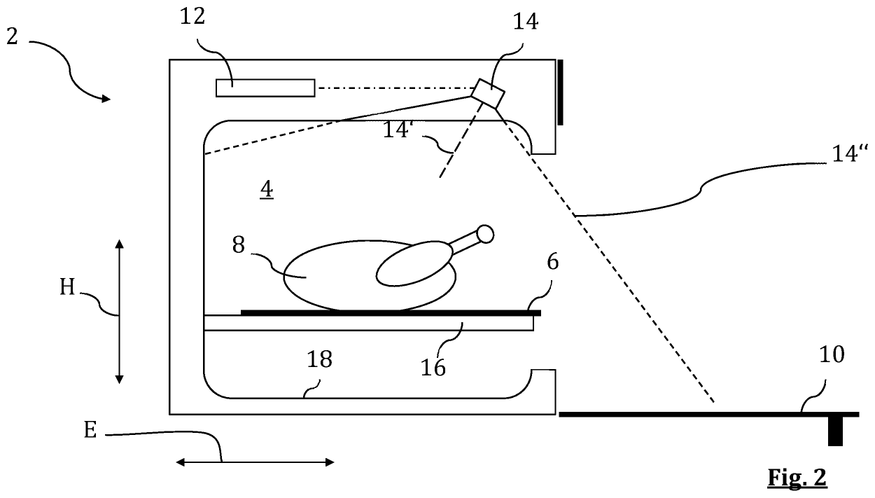

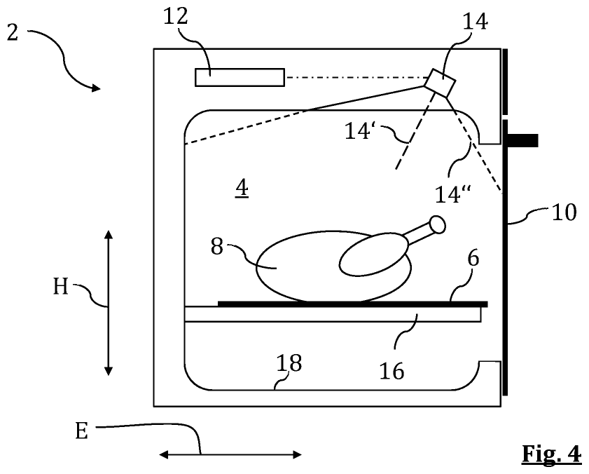

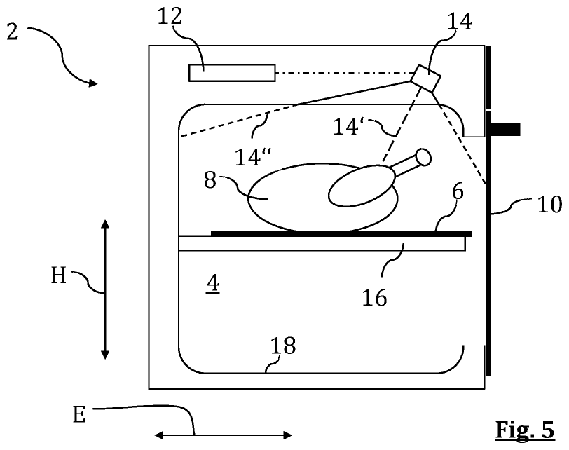

FIGS. 1 to 5 show different embodiments of an inventive cooking appliance 2 including a cooking chamber 4 that is closable by a cooking chamber door 10 and is adapted to receive a food product 8 positioned on a food support 6. Cooking appliance 2 has a treatment device for treating food product 8 as well as a control device 12 for controlling the treatment device. Furthermore, cooking appliance 2 has an image capture device 14 in the form of a camera for capturing images of cooking chamber 4, which image capture device 14 is connected in signal communication with control device 12. Image capture device 14 is adapted to capture 2D images of objects inside and outside the cooking chamber 4 which are located in the detection area 14″ of image capture device 14. Food support 6 rests on a food support holder 16 (e.g., in the form of a telescoping rail assembly) and is thus accurately variable in its insertion depth along insertion direction E (see FIGS. 1 and 2) and in its insertion height along height direction H perpendicular to cooking chamber bottom 18 (see FIGS. 4 and 5). Cooking appliance 2 is suitable and adapted to successively capture a plurality of 2D images of food product 8 by means of image capture device 14, in each of which the food support 6 is in a different insertion position, and to generate 3D information about the shape and/or dimensions of food product 8 by comparing geometric data of food product 8 in the 2D images, this 3D information being taken into account by control device 12 in controlling the treatment device.

Control device 12 serves as an analyzing device that analyzes the captured 2D images to generate the 3D information about food product 8. Control device 12 is suitable and adapted to acquire and compare geometric data of food product 8 and/or of food support 6 in the 2D images. Furthermore, control device 12 is suitable and adapted to generate 3D information about food product 8 based on the 2D images captured from different angles of view. In addition, control device 12 is suitable and adapted to draw conclusions on the type, quantity, mass, and/or other properties of food product 8 based on the 3D information. Based on this data, the cooking process can be accurately tailored to the food product 8 to be prepared, which leads to a better cooking result.

The respective insertion positions of the food support 6 shown in the different 2D images are compared with each other in generating the 3D information. The variation of the insertion position of food support 6 between different 2D images can be determined by sensor means and/or by image analysis.

The optical axis 14′ of the image capture device is inclined relative to a vertical from a perspective perpendicular to height direction H and perpendicular to insertion direction E. In this way, when the insertion depth or the insertion height of food support 6 varies, the imaging angle varies to a greater extent because both the distance of food product 8 to image capture device 14 and the distance of food product 8 to the optical axis of image capture device 14 will always change in the process.

FIGS. 1 and 2 show an embodiment where at least a portion of the 2D images is captured during insertion of food support 6 into cooking chamber 4. The insertion can be carried out manually. In this process, the food support 6 placed on food support holder 16 is, for example, moved by a user along insertion direction E from the partially extended position shown in FIG. 1 to the retracted position shown in FIG. 2. Preferably, the insertion is carried out by motorized retraction of food support holder 16 and in particular at a constant speed. In the process, food support holder 16 may be driven by a drive, which is in particular connected in signal communication with control unit 12. In this case, the control signals for the drive can be used to determine the exact insertion position of food support holder 16.

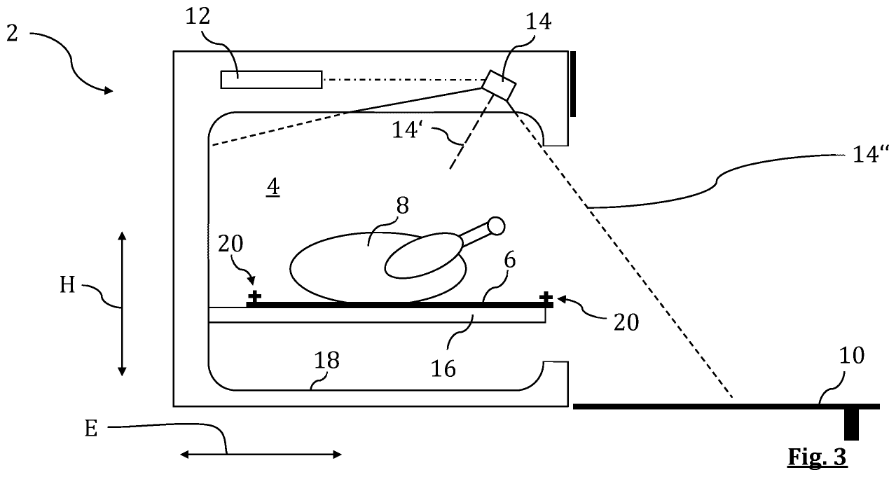

FIG. 3 shows an embodiment where food support 6 has special markings 20 (shown in highly simplified form as crosses), which serve to more accurately determine the variation of the insertion position by means of image analysis. These markings 20 may be in the form of, for example, embossments, imprints, recesses, elevations, or other visually recognizable features, and may be taken into account in the image analysis, either as an alternative or in addition to the usually previously known geometry and/or appearance of food support 6.

FIGS. 4 and 5 show an embodiment where at least a portion of the 2D images is captured during a motorized height adjustment of food support holder 16. In this process, the food support 6 resting on food support holder 16 is driven by a drive and moved along height direction H, for example, from the lower position shown in FIG. 4 to the upper position shown in FIG. 5. The height adjustment is preferably carried out at a constant speed. The drive is in particular connected in signal communication with the control unit, so that the control signals for the drive can be used to determine the exact insertion position of food support holder 16.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for operating a cooking appliance having a cooking chamber for receiving a food product positioned on a food support, a treatment device for treating the food product, a control device for controlling at least the treatment device, and an image capture device for capturing images of the cooking chamber, the method comprising:
successively capturing, using the image capture device, a plurality of 2D images of the food product, in each 2D image of the plurality of 2D images the food support being in a different insertion position, the insertion position being varied at least in insertion height and/or insertion depth;
generating 3D information about a shape and/or dimensions of the food product by comparing geometric data of the food product in the plurality of 2D images; and
using the 3D information for controlling the treatment device.

2: The method of claim 1,
wherein respective insertion positions of the food support shown in the different 2D images are compared with each other in generating the 3D information.

3: The method claim 1,
wherein a variation of the insertion position of the food support between different 2D images is determined by sensor means.

4: The method of claim 1,
wherein a variation of the insertion position of the food support between different 2D images is determined by image analysis.

5: The method of claim 4,
wherein special markings on the food support are considered to determine variation of the insertion position of the food support between different 2D images.

6: The method of claim 1,
wherein the image capture device has an optical axis, which, during capture of the 2D images, is inclined relative to a vertical by 10° to 50°.

7: The method of claim 1,
wherein at least a portion of the plurality of 2D images is captured during insertion of the food support into the cooking chamber.

8: The method claim 7,
wherein the insertion is carried out by motorized retraction of the food support holder at a constant speed.

9: The method of claim 1,
wherein at least a portion of the plurality of 2D images is captured during a motorized height adjustment of a food support holder, the height adjustment being carried out at a constant speed.

10: A cooking appliance, comprising:
the cooking chamber for receiving a food product positioned on the food support;
the treatment device for treating the food product;
the control device for controlling at least the treatment devices; and
the image capture device for capturing images of the cooking chamber,
wherein the cooking appliance is configured to carry out the method claim 1.

11: The method of claim 6, wherein the optical axis is inclined relative to the vertical by 20° to 40°.
